(19) United States
(12) Patent Application Publication
(10) Pub. No.: US 2008/0278582 A1
(43) Pub. Date: Nov. 13, 2008

(54) Video Fusion Display Systems

(75) Inventors: Tat Leung Chung, Alhambra, CA (US); Ulrich Neumann, Manhattan Beach, CA (US); Suya You, Arcadia, CA (US)

Correspondence Address: FISH & RICHARDSON, PC, P.O. BOX 1022, MINNEAPOLIS, MN, 55440-1022, US

(73) Assignee: SENTINEL AVE LLC, El Segundo, CA (US)

(21) Appl. No.: 12/116,166

(22) Filed: May 6, 2008

Related U.S. Application Data
(60) Provisional application No. 60/916,537, filed on May 7, 2007.

(51) Int. Cl. H04N 7/18

(52) U.S. Cl. 348/159; 348/E07.085

(57) ABSTRACT

Methods, systems, and apparatus, including medium-encoded computer program products, for managing video bandwidth over a network connecting one or more cameras and one or more client video display stations. In one aspect, a system includes a data communication network, cameras coupled with the network, arranged in different locations, and operable to provide video imagery of the different locations via the network, one or more video fusion clients operable to display the video imagery of the different locations received via the network, one or more camera manager components operable to manage transmission of the video imagery from the cameras over the network based on client-side information, and one or more client manager components operable to define the client-side information based on display parameters of the one or more video fusion clients.

### CROSS REFERENCE TO RELATED APPLICATION

This application claims the benefit of priority from U.S. Provisional Application Ser. No. 60/916,537, entitled “VIDEO FUSION DISPLAY SYSTEMS”, which was filed on May 7, 2007.

### BACKGROUND

The present disclosure relates to video fusion display systems. Video fusion methods enable multiple video images from multiple cameras to be displayed on a common display, and often in spatial relation to each other. Such systems include GeoVideo (http://www.redhensystems.com/), U. Neumann, S. You, J. Hu, B. Jiang, and J. W. Lee, “Augmented Virtual Environments (AVE): Dynamic Fusion of Imagery and 3D Models,” IEEE Virtual Reality 2003, pp. 61-67, Los Angeles California, March 2003 (herein after “Neumann et al.”), and Video Flashlight (http://www.l3praetorian.com/vflashlight.htm). The essential concept is that imagery is displayed in a manor that implies or conveys the spatial arrangement of the areas being viewed. In some cases this can be simply an arrangement of small images that are positioned on a map or image of the scene, or display can involve a virtual projection of the image onto a 3D model of the scene. Other non-geospatial display arrangements, including simple arrays of images, are also feasible.

### SUMMARY

This specification describes technologies relating to video fusion display systems, including methods and components for bandwidth management and system control, which can result in improved scalability. These technologies can enhance video fusion methods that enable multiple video images from multiple cameras to be displayed on a common display, often in spatial relation to each other, where imagery can be displayed in a manor that implies or conveys the spatial arrangement of the areas being viewed. The bandwidth utilized by one or more cameras connected to a network, such as the Internet, that delivers the video streams to a set of one or more video fusion displays or clients can be managed. A set of methods and system components that manage the bandwidth requirements for cameras and clients in the system can be provided, and the aggregate bandwidth requirements imposed on the network can be efficiently managed. A video-manager (Cvm) element can be inserted into the path of a camera stream, and one or more video manager elements (Fvm) can be added to a video fusion client station.

In general, the subject matter described in this specification can be embodied in a system of fusion client (Fvm) and camera video managers (Cvm) for managing video bandwidth over a network connecting one or more cameras and one or more client video display stations. A system can include a data communication network; cameras coupled with the network, arranged in different locations, and operable to provide video imagery of the different locations via the network; one or more video fusion clients operable to display the video imagery of the different locations received via the network; one or more camera manager components operable to manage (e.g., restrict) transmission of the video imagery from the cameras over the network based on client-side information; and one or more client manager components operable to define the client-side information based on display parameters of the one or more video fusion clients.

The one or more camera manager components can be operable to manage transmission of the video imagery by excluding transmission of imagery from one or more of the cameras and by adjusting video stream parameters. The video stream parameters can include frame rate, image resolution, compression quality, utilized bandwidth, and camera settings (e.g., focus, zoom, pan, tilt, exposure, and camera control functions generally). Moreover, the video stream parameters can control output from various camera components, such as output from a motion sensor and output from an alarm condition detector.

The one or more client manager components can be operable to define the client-side information based on display parameters including available screen area and current client activity. The one or more client manager components can be operable to define the client-side information based on display parameters including number of available screen pixels and current or expected on-screen visibility of projected video. The data communication network can include an inter-network. Moreover, the system can include proxy clients and proxy servers operable to manage bandwidth over a link between two networks in the inter-network.

The one or more camera manager components can include multiple camera manager components. Each camera manager component can be integrated with a respective camera. The multiple camera manager components can be statically or dynamically assigned to video streams from the cameras, including allowing assignment of multiple camera manager components to a single camera stream to manage peak loads. The one or more video fusion clients can include multiple video fusion clients, and the one or more client manager components can include multiple client manager components, each being integrated with a respective video fusion client.

Other embodiments include corresponding methods, apparatus, and computer program products. For example, a method can include, and a computer program product (encoded on a computer-readable medium) can be operable to cause data processing apparatus to perform operations including identifying display parameters of one or more video fusion clients operable to display video imagery of different locations received via a data communication network; generating client-side display information based on the display parameters; and sending the client-side display information to one or more camera manager components operable to manage (e.g., restrict) transmission of the video imagery over the network based on the client-side display information. Generating the client-side display information can include generating the client-side display information based on available screen area and current client activity. Further, generating the client-side display information can include generating the client-side display information based on number of available screen pixels and current or expected on-screen visibility of projected video.

According to another aspect, an apparatus can include a memory; a network interface; and a processor coupled with the memory and the network interface and programmed to perform operations including: receiving client-side information for one or more video fusion clients, receiving video imagery from one or more cameras, and managing (e.g., restricting) transmission of the video imagery over a data communication network to the one or more video fusion clients based on the client-side information. Managing transmission can include adjusting video stream parameters. The video stream parameters can include frame rate, image resolution, compression quality, maximum bandwidth, and camera settings (e.g., focus, zoom, pan, tilt, exposure, and camera control functions generally). Moreover, the video stream parameters can control output from various camera components, such as output from a motion sensor and output from an alarm condition detector.

Particular embodiments of the subject matter described in this specification can be implemented as described below to realize one or more of the advantages mentioned. Cvm elements can be statically assigned to cameras (in line) or dynamically assigned to camera video streams over a shared network. Dynamic assignments of camera video managers can allow for multiple Cvm assignments to a camera stream to manage peak camera loads. Proxy clients and proxy servers can be used to manage bandwidth over a link between two networks. Video bandwidth can be dynamically controlled based on dynamic display characteristics (e.g., the visibility of projected video (visible or not, if so, what percentage visible) and the screen size of a video image (screen area or number of pixels). Moreover, the on-screen visibility (e.g., percentage visibility) can be a current or expected visibility, where the expected visibility can be predicted based on user viewpoint, velocity and path (e.g., using dead reckoning).

Simultaneous independent streams to multiple clients can be controlled, with variable frame rates and image quality, using simultaneous creation and transmission of multiple varied-rate streams to different clients. One or more client Fvm elements can simultaneously request/receive the same stream from a Cvm element (shared stream). Discrete options for frame rate, quality, and size can increase the probability of shared streams.

A Cvm element can compute the streams or access such streams if they already exist, or manage their production by some other hardware or software system. A Cvm element can be a separate computing unit or a software module within an existing camera video computing system. Multiple Cvm elements can be instantiated as a single hardware/software computer system.

A Fvm can be a separate computing unit or a software module within an existing fusion client video display system. Multiple Fvm elements can be instantiated as a single hardware/software computer system. Likewise, the proxy client or proxy server elements can be a separate computing units, or a software module within any computing system on the network, including a fusion client system.

Recorded video as well as live camera video can be used as a source for the fusion system. Record/playback can be inserted between the image source and stream processing of a Cvm element. Record/playback can be from/to a network accessible to the camera and stream processing of a Cvm element. A Master Cvm (MCvm) or Cvm can record a log of camera motion parameters, with time code synchronized to video time code, or embed motion parameters in the video stream. Moreover, playback video time code can be matched to the logged motion parameter time codes, or decoded from the video stream, during playback to feed motion data to client Fvm elements.

The details of one or more embodiments of the invention are set forth in the accompanying drawings and the description below. Other features, aspects, and advantages of the invention will become apparent from the description, the drawings, and the claims.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIGS. 1A, 1B and 1C show video fusion display of mapped video images for GeoVideo and Neumann et al. projection display, and a Neumann et al. thumbnail display.

FIGS. 2A and 2B show four cameras, a network, and three clients.

FIGS. 3A and 3B show two different client views of overlapping portions of the city map and the video images that are related to these portions.

FIG. 4 shows Cvm and Fvm video manager elements added to the example of FIGS. 2A and 2B.

FIG. 5 shows Cvm input and output on separate networks.

FIG. 6 shows a configuration with cameras and Cvm elements on the common Network.

FIG. 7 shows an example system that employs a proxy server and a proxy client.

FIG. 8 shows an example modification of FIG. 5 to include two dual-channel Record/Play elements.

Like reference numbers and designations in the various drawings indicate like elements.

### DETAILED DESCRIPTION

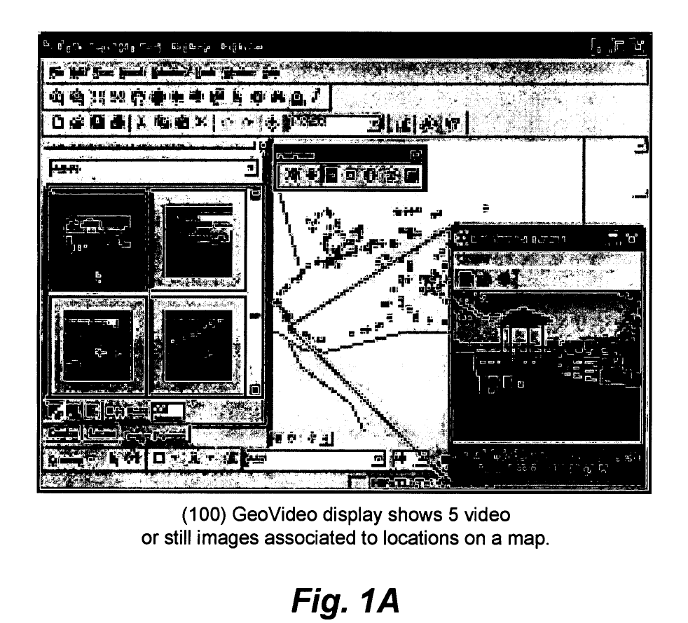

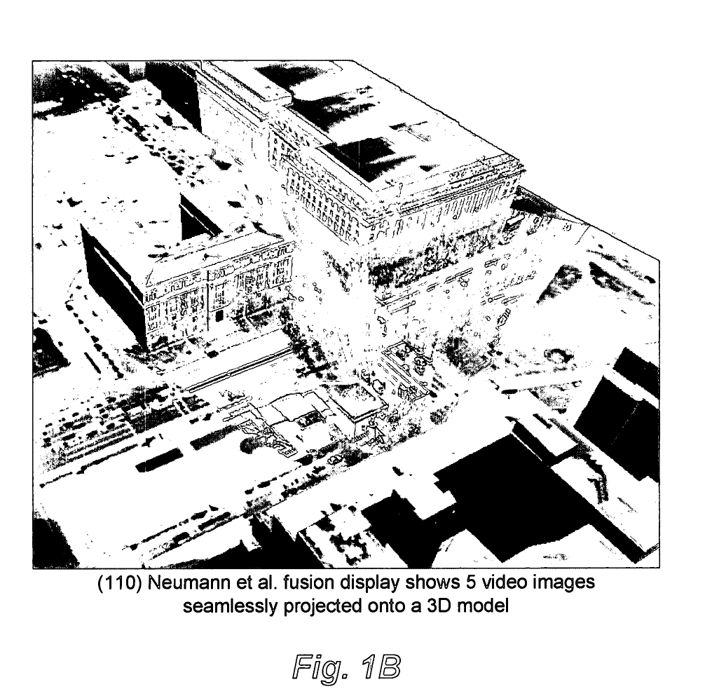

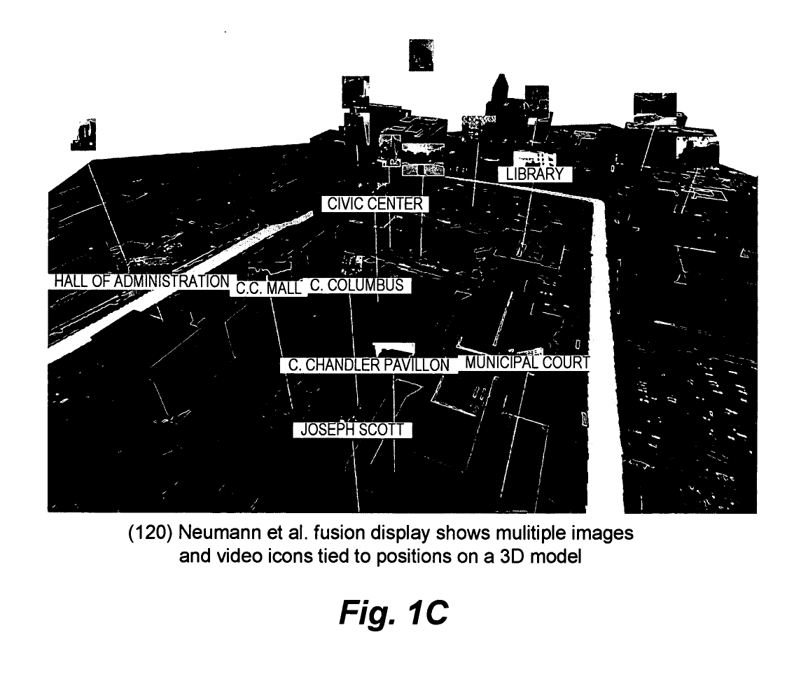

FIGS. 1A, 1B and 1C show video fusion display of mapped video images (100) for GeoVideo and Neumann et al. projection (110) display, and a Neumann et al. thumbnail (120) display. It should be noted that the various references to Neumann et al. based features does not constitute an admission that such features are prior art. The video fusion display system (110) and (120) is capable of changing the viewpoint either automatically or under user control to display images associated with different areas of the 3D model. The fusion display may also allow the display of smaller (zoom in view) or larger scene areas (zoom out view) that include varying numbers and screen sizes of video images. FIG. 1B (110) shows five video images seamlessly projected onto a 3D model. FIG. 1C (120) shows thumbnail images tied to locations in a 3D model. FIG. 1A (100) shows images associated to a map of their location.

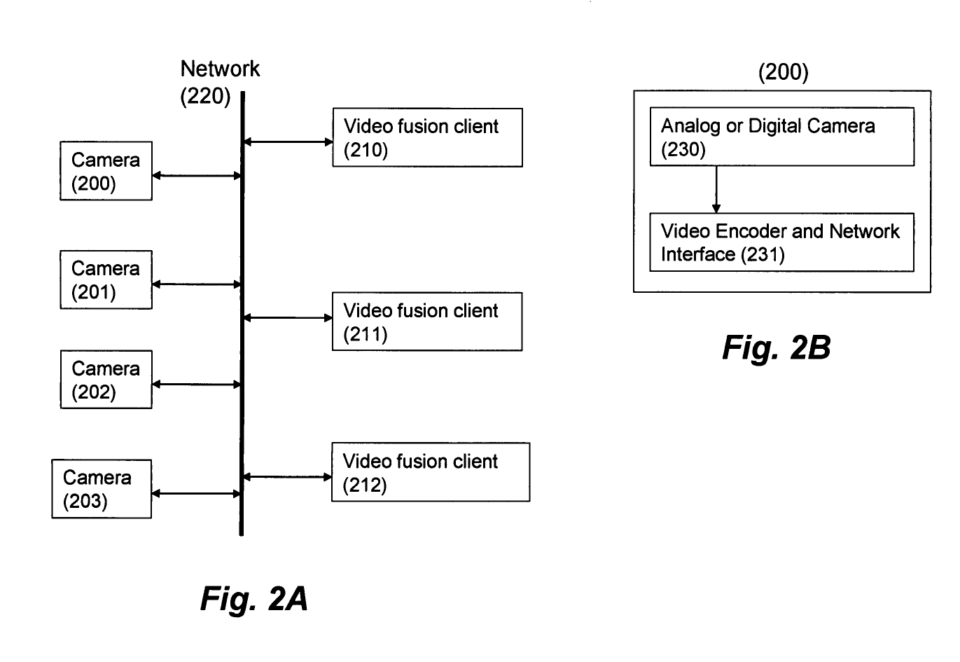

Within this context, the bandwidth utilized by one or more cameras connected to a network, such as the Internet, that delivers the video streams to a set of one or more video fusion displays or clients can be managed to improve performance and scalability. FIGS. 2A and 2B show four cameras (200-203), a network (220), and three clients (210-212). Video camera components may comprise separate analog or digital cameras (230) with video encoders and network interfaces (231), or integrated digital cameras with network interfaces (201-203). In any case the network interface provides image data to the network. Furthermore, the image data passed over the network may be raw image pixel data or compressed image data using any compression method, such as MPEG or motion JPG. The network (220) can be a shared digital network, such as the Internet, or other networks (including proprietary networks). The clients (210-212) are display systems with network interfaces that obtain their displayed video imagery from the network. These clients may be any mix of GeoVideo or Neumann et al. systems or other video fusion display systems. The cameras and clients may be distributed over arbitrary locations and distances, providing they have access to the network.

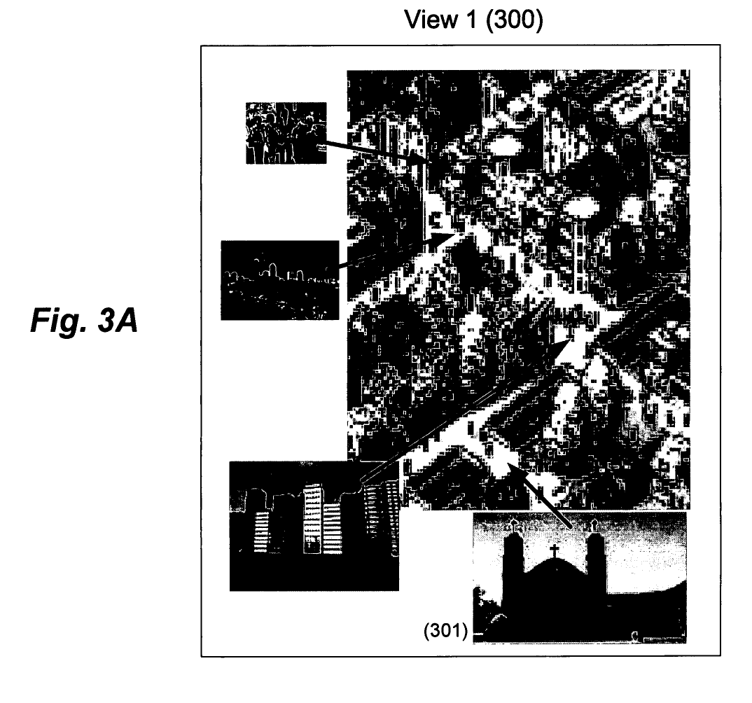

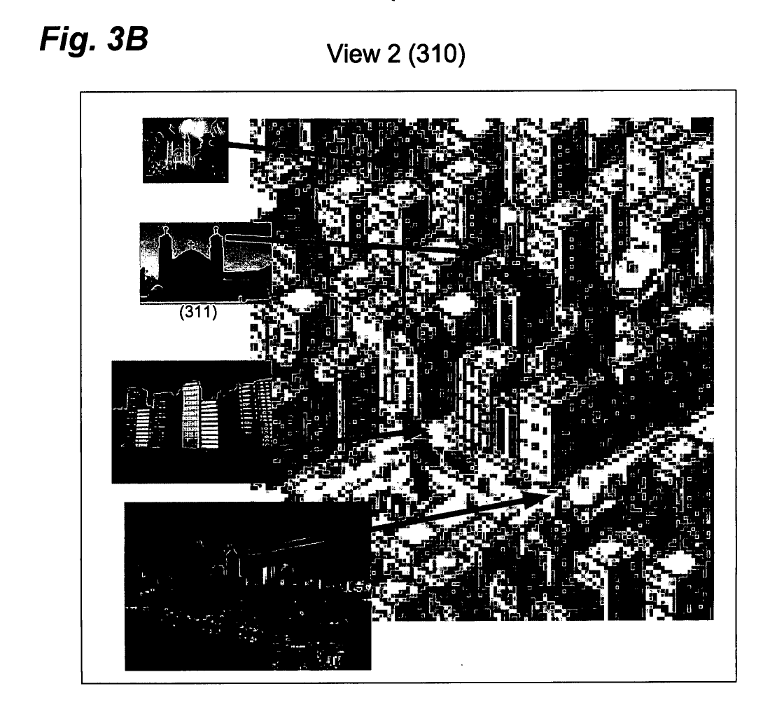

Consider an example of C=50 cameras located at different intersections of a city. All cameras access the network. There are F=20 fusion display client stations on the network, each independently viewing the video imagery placed on a map drawing of a city. FIGS. 3A and 3B show two different client views of overlapping portions of the city map and the video images that are related to these portions. Note that each view shows some different portions of the city map and therefore the display may show some different video images. In the overlapping portions of the map, the common video images shown in both views can be displayed at different sizes. For example in View 1 (300) a video clip of a building (301) was taken from near the map viewpoint and therefore the video clip is shown relatively large on the display screen. The same video clip (311) is farther away from the second map viewpoint (310) and therefore the clip is shown as a smaller image on the display. The point of this example is not to argue for why the clips are shown as larger or smaller images on the display, since various criteria can be used, but rather to note that the clips can be shown in different images sizes on the fusion system display screen.

If video image streams from all cameras are sent to all client display stations regardless of what area is actually displayed at each station, this imposes a great performance burden upon the cameras, the network, and the clients. The performance cost imposed on a camera is Cc, which is the rate of data the camera feeds to the network. Each camera feeds F clients, requiring it to send F copies of its imagery over the network via its network interface. As the number of client stations increases, the performance cost Cc for each video camera also increases proportionally, Cc ∝ F.

The performance cost imposed on a network is Nc, which is the aggregate rate of all the data passed over the network. In the above described scenario, the network delivers a copy of each camera's data to each client. This means that the network passes F×C video streams. This requirement means that the network performance cost, Nc ∝ F×C, grows rapidly as the number of cameras and clients increase.

Moreover, the performance cost imposed on a client fusion display is Fc, which is the aggregate rate of all the camera data received and processed by the station. Each client receives C video streams, or one stream for each camera. As the number of cameras grows to cover additional parts of the city or other cities, the number of streams and the client cost to receive and process these streams, Fc ∝ C, grows proportionally.

Thus, the approach of sending all camera streams to all clients does not effectively scale to larger systems with high numbers of cameras and clients. In part to address this problem, the subject matter described here provides a set of components and methods for managing the camera, network, and client performance costs so that large video fusion systems can be constructed and operated efficiently and within the limitations of the given camera, network, or client performance capabilities. The described methods and system components that manage the bandwidth requirements for each camera and client can also efficiently manage the aggregate bandwidth requirements imposed on the network. Bandwidth is a measure of the performance costs described above.

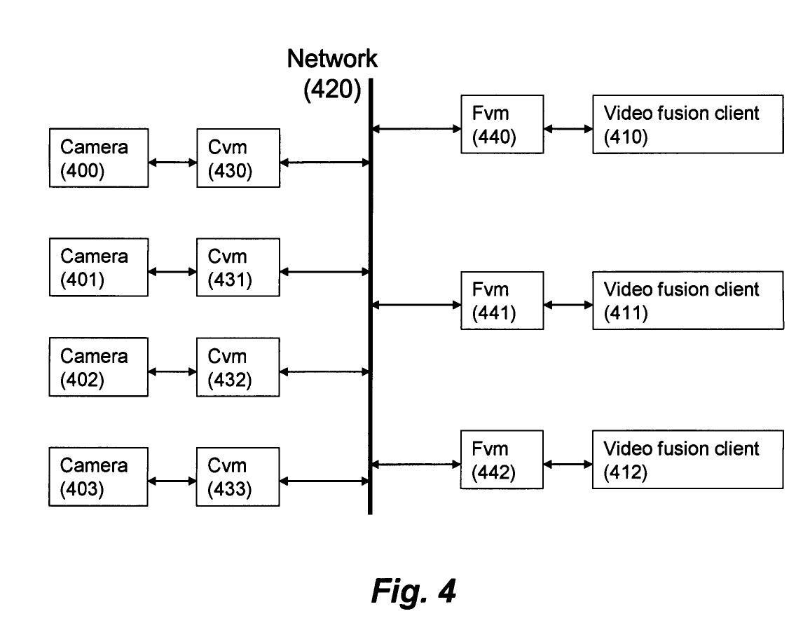

A video-manager (Cvm) element can be inserted into the path of each camera stream. In addition, video manager elements (Fvm) can be added to each video fusion client station. FIG. 4 shows Cvm (430-433) and Fvm (440-442) video manager elements added to cameras (400-403) and clients (410-412), such as exemplified in connection with FIGS. 2A and 2B. The Cvm and Fvm elements can communicate over the same network used to transport the video streams from cameras to client stations. These additional communications impose small performance cost or bandwidth relative to the network capabilities and the video streams sent over the network.

Each client station is presumed to view a subset R of all the available camera images S. Formally, R is a proper subset of S (R⊂S) and R is the set of currently visible camera images on a client display. When a client requires image subset R for its current display, the client's Fvm element requests those image streams by communicating with the Cvm elements that manage the set of cameras producing image set R. The request can be a simple command to send the stream, or the request can include parameters for adjusting the stream based on processing done by the Cvm elements or under the control of the Cvm elements. Parameters that impact the processing include, but are not limited to, frame rate, image resolution, compression quality, maximum bandwidth, exposure setting, and settings for camera motion (pan, tilt, zoom), lighting, or any other control over the camera or stream. The parameters that impact the camera or stream processing can also include control over the output of various camera components, such as the output from motion sensors or alarm condition detection algorithms employed by the cameras or image processing systems.

Bandwidth is limited by this Fvm-to-Cvm communication since camera video streams are only sent to clients that need the streams for their display or other purposes. In addition, as clients add more camera images to their displays, the images become smaller since each image can only occupy a smaller fraction of the screen, therefore lower resolution images can be sent from the camera to the client. As image resolution is reduced, the bandwidth required to send the images is also reduced. In addition, clients may request reduced frame rates or image quality as images become smaller or less important to the client activity. In general, by controlling the distribution, resolution, frame rate, and quality, of video streams through Fvm-to-Cvm communication, the overall bandwidth and performance requirements of the system components are reduced.

The Neumann et al. system is an example of a fusion client that allows continuously varying view control, allowing users arbitrary views into the scene. In such clients, video is projected onto 3D models and a view change may cause a video projection to become visible, or become fully occluded, or move off screen. The Fvm element in the client is notified by the client application when any change in visibility of a video stream occurs. The client Fvm then communicates with the Cvm elements to start or stop or alter the transmission of the affected video streams. Visibility calculations are common in 3D computer graphics, and visibility algorithms can determine the visibility of a video projection onto a 3D model when viewed from arbitrary view points. Graphics software libraries also include functions to compute such visibility functions, for example the OpenGL function glGetOcclusionQuery( ) computes a visibility function. Similarly, the screen size of a projection can be estimated by a bounding box and the box size can be used by the client application and its Fvm element to instruct the camera Cvm element to adjust the resolution or size of the related camera stream. This ensures that as a client viewpoint moves farther away from a video projection, the bandwidth required by that projection is reduced proportionally. In the limit, an extremely high client viewpoint may look down at a scene containing an entire city of cameras, where only one pixel from each camera is displayed and each pixel in the client display comes from a different camera. While this is an extreme case, it illustrates the crucial point that there is a bound on the number of video pixels that need to be transmitted to any client. The bound is the number of pixels in the client display. For example, if we have a client display with 1 million pixels, those pixels can be filled from one high resolution camera feeding its full 1 million pixel resolution image stream to the client, or from a million different cameras, each feeding a one-pixel image to the client. In either case, the client need only receive and process one million pixels of video data per frame. The method of Fvm-to-Cvm communication described herein can ensure that in either extreme and in all cases in between, the total number of video pixels sent to a client station can be bounded, and therefore the bandwidth requirements on the network and the cameras is also bounded.

Pseudo code is now provided to show a detailed example in which, for the sake of clarity, only visible screen pixels are used as client side display information, and a Cvm handles only one camera.

```
Fvm
=========================================
Startup
  For each camera i
  {
  Send MCvm request for camera i
  Get reply from MCvm, Cvm[i] is now assigned for Fvm[i]
  Send Cvm[i] Add Fvm client request
  }
Running
  For every frame
  {
    For each camera i
    {
      Get camera visible screen pixels p(i)
      Compute request resolution R(i) from one of the predefined
      video size
      (e.g. R6 = 1024x768, R5 = 740x480, R4 = 360x240, ...,
R0 = 0 => stop video)
      If (R(i) <> lastR(i))
      {
        send video resolution change request to Cvm[i]
        lastR(i) = R(i)
        }
    }
  }
Shutdown
  For each camera i
  {
    send Cvm[i] Exit client request
  }
Cvm
=========================================
Data Structure
CamClients
{
  List of Fvms using this resolution
  video frame F
}
CamClients CameraTable[NResolution]
Array of Fmv
Network Thread
----------------------------------
For each request from Fvm
{
  if (video resolution change request)
  {
  Modify CameraTable to add/change/remove Fvm list
  }
  if (Fvm Exit client request)
  {
    if (this is the last one in Fmv Pool)
    {
      Send Cvm shutdown request to MCvm
    break;
    } else {
      Remove client from Fvm Pool
    }
  }
  if (Fvm Add client request)
  {
    Add client to Fvm pool
  }
}
Main Thread
------------------------
For each new frame M from camera
{
  For each resolution j in CameraTable from highest to lowest
  {
    If CameraTable[j] Fvm list is not empty
    {
      Compute video frame F(j) from M or last compute F(i), i < j
    }
  }
  Compute frame rate for each Fvm based on target network bandwidth
  For each resolution j in CameraTable except j = 0 (means stop)
  {
    For each Fvm in CameraTable[j]
    {
      If (Fvm satisfy frame rate requirement)
      {
        Send video frame F to Fvm
      }
    }
  }
}
MCvm
=========================
Data Structure
Array of Cvm
For each network request
{
  if (new camera C request from Fvm)
  {
    if (Cvm not in known Cvm Pool)
    {
      Allocate Cvm from machine with lowest CPU utilitization
    } else {
      Find Cvm from current Cvm Pool
    }
    Reply Fvm the assigned Cvm
  }
  if (Shutdown request from Cvm)
  {
    Remove from current Cvm Pool
  }
}
```

The above discussion relates to a fusion system with a single client display station. However, the subject matter is also applicable to multiple client systems. Each client Fvm element can communicate with the Cvm element for each camera whose video is required by the client. The Fvm-to-Cvm communication can set the parameters of all streams delivered by the network. In many cases the clients request streams from different sets of cameras, for example, when one client views the North portion of a city and another client views the Southern portion of the city. When two or more clients require streams from the same camera, the Cvm element at the camera can create and manage the two client streams independently. For example, one client may require a full resolution image at the maximum frame rate and highest image quality. The other client may only require a half-resolution image, at ¼ the frame rate, and 1/10^{th} the image quality. The Cvm element can compute or access the required two streams from the camera output, and transmit the two streams independently. In this fashion, the bandwidth from camera to Cvm and the network bandwidth to each client can be minimized, as in the single client case. The added Cvm burden of managing independent streams for each client is offset by two factors. First, the probability of multiple clients requesting the same camera image decreases as the number of camera images available on the network increases. Second, the burden of creating streams of varied compression quality, frame rates, and resolutions can be offset by allowing only a fixed set of stream options that are efficiently created. For example, image resolutions of ½, ¼, ⅛, and 1/16 full size are easily created by recursive one-dimensional resampling or pixel averaging. Such methods are well known in computer graphics and image processing. Similarly, reductions in frame rate can be achieved by simply skipping frames. Compression quality options may only be available in full size images and in a limited number (e.g., 2 or 3) of steps. Allowing only a limited set of options also increases the probability that multiple clients require the same stream, thereby eliminating the need to compute a unique stream for each client.

Even when improbable events cause a high number of requests to the same camera, the Cvm element can degrade gracefully, providing proportional reduced performance to all requesting clients. Alternately, the Cvm element can prioritize its streams based on the importance of clients or their request sequence. Image size, quality, and frame rate may be reduced to provide streams to more clients.

In addition, various configurations of the Fvm and Cvm elements are possible. Each Fvm or Cvm element can be a physically distinct system, such as a computing processor, interfaces, and software on one or more circuit boards. Alternately, multiple Fvm or Cvm elements can be implemented within a single physically distinct system. In addition, the Cvm elements can be integrated within a camera's circuitry and firmware, thereby providing the Cvm network interface as a camera connection. Similarly, the Fvm elements may be integrated within the client station computing system, thereby providing the Fvm network interface as a client connection.

Various network configurations are also possible. The Cvm and Fvm elements can be configured in various ways, with respect to the network, the cameras, and the client stations. FIG. 4 shows Cvm elements between the camera and the Network (420), and each Cvm element is thereby assigned to a camera. FIG. 4 also shows Fvm elements between a client station and the Network, thereby assigning each Fvm element to a client station.

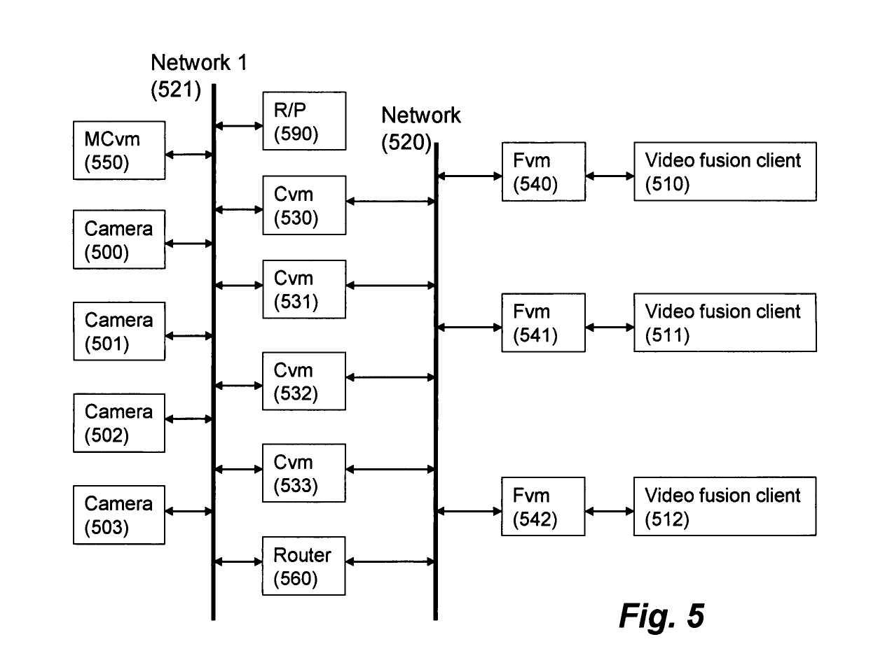

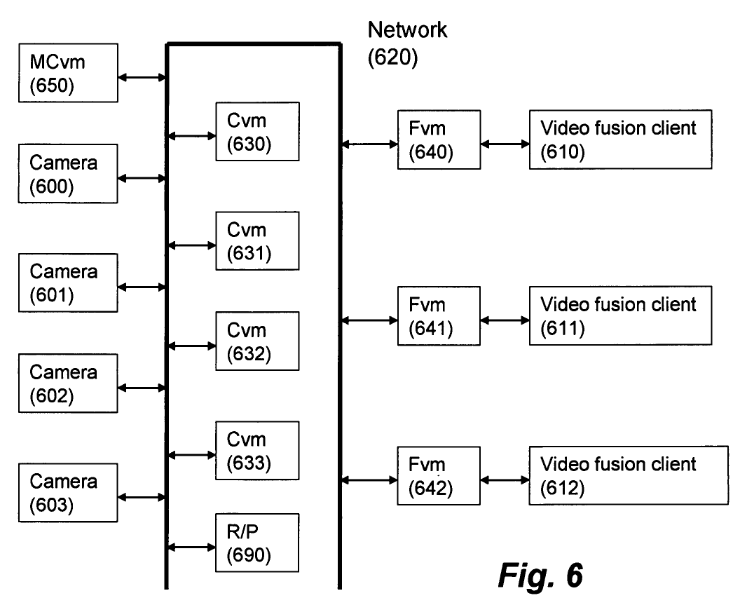

Alternatively, multiple cameras and Cvm elements can be connected to networks. FIG. 5 shows Cvm input and output on separate networks (520, 521). Also shown is a router (560) or similar communication device to provide limited or complete connectivity between the networks for general data. The Cvm elements can also share the same network with the cameras. FIG. 6 shows a configuration with cameras and Cvm elements on the common Network (620).

In either of the configurations shown in FIGS. 5 and 6, the assignment of Cvm elements (530-533, 630-633) to cameras (500-503, 600-603) can be static or dynamic. Dynamic assignment can be managed by a Master Cvm (MCvm) element (550, 650). The MCvm element in FIG. 5 is shown connected to Network 1 (521), however it may also be connected to the Network (520) since the router (560) allows communication to pass between the networks. Similarly, there may be multiple instances of Network 1 (521) and routers (560), that connect clusters of cameras and Cvm elements to each other and to the common Network (520) within a large system.

For the configurations shown in FIGS. 5 and 6, client station Fvm elements (540-542, 640-642) request camera video streams from the MCvm element, which in turn dynamically assigns Cvm elements to cameras to process the stream requests. Once a camera has a Cvm element assigned to it, all requests for streams from that camera are handled by its assigned Cvm element. The configurations shown in FIGS. 5 and 6 allow for a dynamic assignment of Cvm elements to cameras, and therefore allow a relatively small number of Cvm elements to be dynamically assigned to a much larger pool of cameras. Dynamic assignments allow for an efficient use of resources when the client stations (510-512, 610-612) are collectively only observing a subset of all possible cameras at any one time.

The configurations in FIGS. 5 and 6 also allow for the assignment of multiple Cvm elements to a camera in order to maintain system performance during excessive loads on a subset of cameras. For example, if a very large number of client Fvm elements request a particular camera's video stream, the requests for streams may exceed the assigned Cvm element's ability to produce all the streams. In this case, the MCvm allocates one or more additional Cvm elements to handle a subset of the requested streams. These additional Cvm elements obtain their input video stream(s) from either the camera or the initially allocated Cvm element. The additional Cvm elements process and forward steams exactly the same as those previously described.

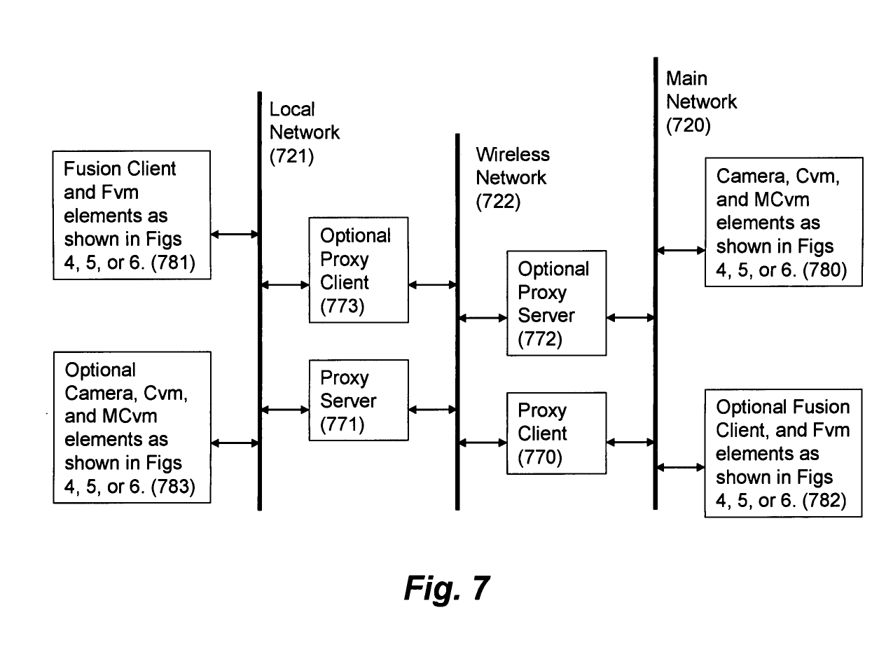

Proxy servers and clients can also be employed. A proxy server (PS) and proxy client (PC) are separate elements on networks that act on behalf of one or more cameras or clients, respectively. Their purpose is to manage the bandwidth between separate networks or portions of a network. Such need arises when a remote client (or set of clients) has a limited connection to the main network and there is a need to control the bandwidth used for video over that connection. For example, as shown in FIG. 7, remote client station Fvm elements (781) connect to a local network (721) that shares a wireless network (722) that connects to a main network (720). The wireless link only provides a 1 megabit/second bandwidth that must be shared with other users and other applications connected to the local network (721). Both networks (720, 721) may host complete video fusion systems, as shown in FIGS. 4, 5, and 6 (780 and 782, 781 and 783). At minimum, one network (720) has one or more camera and Cvm elements, and one MCvm element (780); and the other network (721) has one or more fusion client and Fvm elements (781). Video streams are allocated up to 0.4 megabits/second over the wireless link and the remaining link bandwidth must remain available for other applications. In this example, the local Fvm and client elements (781) use a PS element (771) to access the video streams from cameras (780) on the main network (720). The PC (770) gathers the needed camera video streams from camera Cvm elements and passes them over the wireless link to the PS (771) that provides streams to the local Fvm elements and their client stations (781).

The Fvm elements and their clients (781) on the local network (721) use the PS (771) as a proxy for the MCvm and Cvm elements assigned to the main network cameras. Local client Fvm elements request main network camera streams from the PS, and the Cvm stream management functions for these streams are either computed by the PS or by local Cvm elements on the local network (783). At least one copy of all the camera video streams required by the local client Fvm elements should pass over the wireless network. The PS requests at least one copy of each of the requested camera streams from the PC, with parameters for each stream specifying the stream's frame rate, image quality, and resolution. The stream parameters can be set to ensure that the bandwidth allotted to video on the wireless network is not exceeded. The PS may request streams with reduced image size, resolution, and frame rate parameters, rather than the stream parameters requested by client Fvm elements, to ensure that the bandwidth used over the wireless link does not exceeded allocated levels. In managing these parameters to control the wireless link utilization, a best effort service is provided by the PS for the video steams requested by the local client station Fvm elements.

The PC accepts video stream requests from the PS and forwards the requests to the MCvm or Cvm elements on the main network. In this activity, the PC acts as a proxy for all the local network client stations and their Fvm elements. Example operations of the proxy elements are now described.

If there are only Client and Fvm elements on the local network:
1. A remote client Fvm element requests a video stream for a main network camera from the local network Proxy Server.
2. The PS aggregates all the quality/resolution/frame rate requests for each camera from local network client Fvm elements and sends a stream request to the Proxy Client. The stream request uses the best resolution/quality/frame rate parameters possible given all current stream requests and the bandwidth allocation on the wireless link.
3. The Proxy Client on the main network gets a PS stream request and forwards it to the main network MCvm element, which allocates a Cvm element, or forwards the request to an already assigned Cvm element, for the video stream.
4. The assigned Cvm elements sends the requested stream to the PC, which in turn forwards the stream to the PS over the wireless link.
5. The PS sends the received stream to all local network client Fvm elements that requested it, or processes the stream to provide the quality/resolution/frame rate requested by client Fvm elements.

If there are Client and Fvm elements as well as cameras, Cvm, and MCvm elements on the local network:
1) A remote client Fvm element requests a video stream for a main network camera from the local network MCvm.
2) The local MCvm may allocate a local Cvm element to manage this camera stream on the local network, or it forwards the request to an existing local Cvm element assigned to that camera stream.
3) The Cvm gathers all the quality/resolution/frame rate requests for the video stream from local network client Fvm elements and sends a request using the best resolution/quality/frame rate parameters to the PS.
4) The PS relays stream requests to the main network PC, optionally altering the stream parameters to limit the bandwidth utilized on the wireless link.
5) The PC receives the request and forwards it to main network MCvm element.
6) The main network MCvm either assigns a Cvm element to handle the stream or forwards the request to an existing Cvm element assigned to the video stream.
7) The Cvm obtains the requested camera video stream from a main network camera.
8) The Cvm forwards a stream, based on the request parameters, to the PC, which relays it to the PS.
9) The PS relays the image to the requesting local network Cvm element.
10) The Cvm element processes the stream to produce and forward the requested client Fvm streams.

If cameras are present on the remote network (783), their streams may be accessed by client Fvm elements (782) on the main network or other local networks, via proxy server (772) and proxy client (773) elements that operate in the same fashion as already described above.

In addition to managing video streams, the MCvm element or a Cvm element assigned to a camera can also manage the state of the camera. This is important for moving or PTZ (Pan, Tilt, Zoom) cameras since any client Fvm element may request a change in camera position and all clients receiving streams from the Cvm element at that time need to be informed of the change. The current camera position parameters can be distributed to all current clients by the Cvm or MCvm element, if desired, and clients requesting streams can also request the current camera position parameters.

Video fusion displays from live camera streams or recorded streams can be managed the same in a system, as long as the recording and playback of video streams occurs at a point where the full resolution camera image is accessible. One or more Record/Play (R/P) elements receive full resolution video streams from a subset or all cameras for recording. During playback, the R/P elements feed recorded video into the same network, replacing the live camera streams. Stream processing and Cvm element stream forwarding remains the same regardless of whether a stream is live or recorded. The configurations of FIG. 5 and 6 show a multichannel digital record/play element (590, 690) on the network.

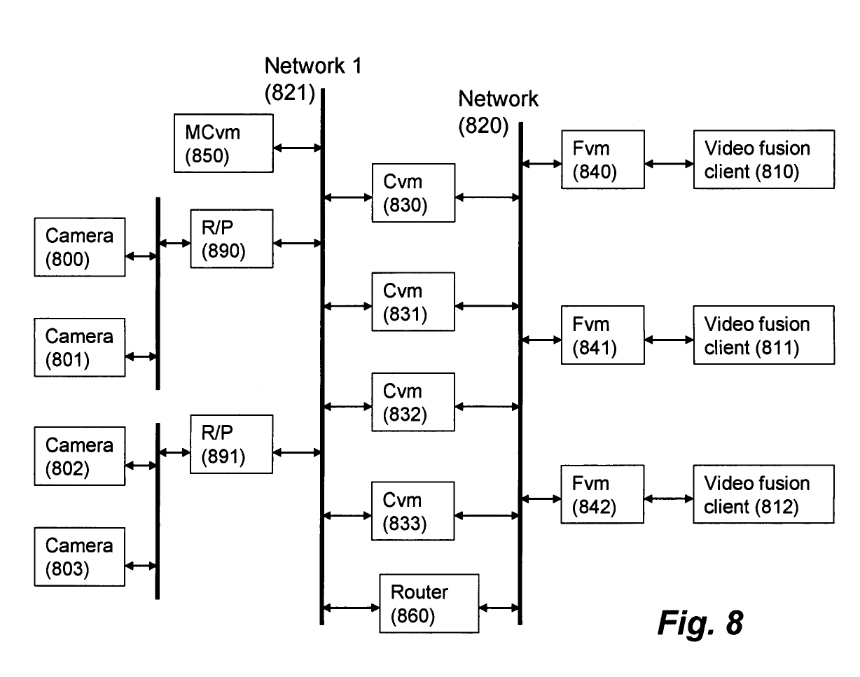

Commercial digital video R/P devices have a single network connection or two connections with feed-through of live video and output of recorded video. The examples shown in FIG. 5 and 6 assume a single network connection R/P element. A two-connection R/P element requires that one or more cameras feed through the R/P element, as shown in FIG. 8, which includes cameras (800-803), MCvm element (850), networks (820, 821), router (860), Cvm elements (830-833), Fvm elements (840-842) and video fusion clients (810-812), and which is modified from FIG. 5 to include two dual-channel R/P elements (890, 891).

Camera motion parameters may or may not be possible to record in commercial video record/playback systems. When such recording is not possible, the MCvm or Cvm element can maintain a time stamped log of motion parameter changes for each movable camera in memory or on a storage device such as a hard drive. The time stamp can be the same as the time stamp used by the video recorders or their time sources are synchronized during a system initialization or at a periodic interval. During video playback, the playback video time code is matched to the log of camera motion parameter changes. When a logged motion parameter change time code matches the playback time code, the recorded motion parameters are sent to all client Fvm elements receiving video from the moving camera. This ensures that all client displays reflect changes in the recorded camera positions during playback of video. The client display systems therefore behave the same with recorded video as with live video. In both cases, camera motion changes are propagated by the MCvm or Cvm elements to the client systems.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a computer-readable medium for execution by, or to control the operation of, data processing apparatus. The computer-readable medium can be a machine-readable storage device, a machine-readable storage substrate, a memory device, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the invention have been described. Other embodiments are within the scope of the following claims. For example, the actions recited in the claims can be performed in a different order and still achieve desirable results.

What is claimed is:

1. A system comprising:
a data communication network;
cameras coupled with the network, arranged in different locations, and operable to provide video imagery of the different locations via the network;
one or more video fusion clients operable to display the video imagery of the different locations received via the network;
one or more camera manager components operable to manage transmission of the video imagery from the cameras over the network based on client-side information; and
one or more client manager components operable to define the client-side information based on display parameters of the one or more video fusion clients.

2. The system of claim 1, the one or more camera manager components operable to manage transmission of the video imagery by excluding transmission of imagery from one or more of the cameras and by adjusting video stream parameters.

3. The system of claim 2, wherein the video stream parameters comprise frame rate, image resolution, compression quality, utilized bandwidth, and camera settings.

4. The system of claim 2, wherein the video stream parameters control output from a motion sensor and output from an alarm condition detector.

5. The system of claim 1, the one or more client manager components operable to define the client-side information based on display parameters comprising available screen area and current client activity.

6. The system of claim 1, the one or more client manager components operable to define the client-side information based on display parameters comprising number of available screen pixels and on-screen visibility of projected video.

7. The system of claim 1, wherein the data communication network comprises an inter-network.

8. The system of claim 7, further comprising proxy clients and proxy servers operable to manage bandwidth over a link between two networks in the inter-network.

9. The system of claim 1, wherein the one or more camera manager components comprise multiple camera manager components.

10. The system of claim 9, wherein each camera manager component is integrated with a respective camera.

11. The system of claim 9, wherein the multiple camera manager components are dynamically assigned to video streams from the cameras, including allowing assignment of multiple camera manager components to a single camera stream to manage peak loads.

12. The system of claim 1, wherein the one or more video fusion clients comprise multiple video fusion clients, and the one or more client manager components comprise multiple client manager components, each being integrated with a respective video fusion client.

13. An apparatus comprising:
a memory;
a network interface; and
a processor coupled with the memory and the network interface and programmed to perform operations comprising: receiving client-side information for one or more video fusion clients, receiving video imagery from one or more cameras, and managing transmission of the video imagery over a data communication network to the one or more video fusion clients based on the client-side information.

14. The apparatus of claim 13, wherein managing transmission comprises adjusting video stream parameters.

15. The apparatus of claim 14, wherein the video stream parameters comprise frame rate, image resolution, compression quality, maximum bandwidth, and camera settings.

16. The apparatus of claim 14, wherein the video stream parameters control output from a motion sensor and output from an alarm condition detector.

17. A computer program product, encoded on a computer-readable medium, operable to cause data processing apparatus to perform operations comprising:
identifying display parameters of one or more video fusion clients operable to display video imagery of different locations received via a data communication network;
generating client-side display information based on the display parameters; and
sending the client-side display information to one or more camera manager components operable to manage transmission of the video imagery over the network based on the client-side display information.

18. The computer program product of claim 17, wherein generating the client-side display information comprises generating the client-side display information based on available screen area and current client activity.

19. The computer program product of claim 17, wherein generating the client-side display information comprises generating the client-side display information based on number of available screen pixels and on-screen visibility of projected video.

20. A method comprising:
identifying display parameters of one or more video fusion clients operable to display video imagery of different locations received via a data communication network;
generating client-side display information based on the display parameters; and
sending the client-side display information to one or more camera manager components operable to manage transmission of the video imagery over the network based on the client-side display information.

21. The method of claim 20, wherein generating the client-side display information comprises generating the client-side display information based on available screen area and current client activity.

22. The method of claim 20, wherein generating the client-side display information comprises generating the client-side display information based on number of available screen pixels and on-screen visibility of projected video.

23. A computer program product, encoded on a computer-readable medium, operable to cause data processing apparatus to perform operations comprising:
receiving client-side information for one or more video fusion clients;
receiving video imagery from one or more cameras; and
managing transmission of the video imagery over a data communication network to the one or more video fusion clients based on the client-side information.

24. The computer program product of claim 23, wherein managing transmission comprises adjusting video stream parameters.

25. The computer program product of claim 24, wherein the video stream parameters comprise frame rate, image resolution, compression quality, maximum bandwidth, and camera settings.

26. The computer program product of claim 24, wherein the video stream parameters control output from a motion sensor and output from an alarm condition detector.

27. A method comprising:
receiving client-side information for one or more video fusion clients;
receiving video imagery from one or more cameras; and
managing transmission of the video imagery over a data communication network to the one or more video fusion clients based on the client-side information.

28. The method of claim 27, wherein managing transmission comprises adjusting video stream parameters.

29. The method of claim 28, wherein the video stream parameters comprise frame rate, image resolution, compression quality, maximum bandwidth, and camera settings.

30. The method of claim 28, wherein the video stream parameters control output from a motion sensor and output from an alarm condition detector.
